(19) United States
(12) Patent Application Publication
(10) Pub. No.: US 2015/0103772 A1
(43) Pub. Date: Apr. 16, 2015

(54) Routing of Traffic in a Multi-Domain Network

(71) Applicants: Roberto David Carnero Ros, Madrid (ES); Avelina Pardo-Blazquez, Madrid (ES)

(72) Inventors: Roberto David Carnero Ros, Madrid (ES); Avelina Pardo-Blazquez, Madrid (ES)

(73) Assignee: Telefonaktiebolaget L M Ericsson (publ), Stockholm (SE)

(21) Appl. No.: 14/401,171

(22) PCT Filed: May 16, 2012
(86) PCT No.: PCT/EP2012/059181

§ 371 Date: Nov. 14, 2014

(51) Int. Cl. H04L 12/715; H04W 40/02

(52) U.S. Cl. CPC H04L 45/04; H04W 40/02
USPC 370/329

(57) ABSTRACT

A multi-domain network comprises a first network domain, e.g., a fixed access domain, and a second network domain, e.g., a cellular network domain. The first network domain includes a gateway (24) providing a first access to a packet network. The second network domain includes a further gateway (14) providing a second access to the packet network. A policy controller determines an anchoring rule for controlling whether the gateway (24) selects a first route (25) or a second route (15) for data traffic of a user equipment. The first route extends between the gateway (24) and the first access, and the second route extends, via the further gateway (14), between the gateway (24) and the second access. Further, the policy controller sends control data to control application of the anchoring rule by the gateway (24).

### TECHNICAL FIELD

The present invention relates to methods for routing data traffic in a multi-domain network and to corresponding devices.

### BACKGROUND

In telecommunication networks, there is a general need for techniques which allow for efficient network management by reusing architectures designed for different types of network access, such as fixed broadband access and cellular mobile access networks. This is also referred to as “Fixed and Mobile Convergence” (FMC). In an FMC network, there are different network domains, a cellular network domain and a fixed access domain, which can be alternatively used by a user equipment (UE) for connecting to the Internet or to some other type of packet network. Architectures for FMC are for example provided by 3^{rd} Generation Partnership Project (3GPP) Technical Specification (TS) 23.402 and TS 23.139 and are also addressed by developments in the Broadband Forum (BBF). Such FMC architectures allow for enabling the use of fixed broadband accesses, e.g., a Wireless Local Area Network (WLAN) or FemtoCell connected to a BBF network, to 3GPP users. The fixed broadband access may then be used by as an alternative way for the 3GPP user to access the Internet.

In known FMC architectures, there are generally two possibilities of routing traffic of a UE that is making use of a BBF access. According to a first possibility, the traffic can be routed through the 3GPP Evolved Packet Core (EPC). According to a second possibility, the traffic can be offloaded directly from the BBF network domain to the Internet, without being passed through the 3GPP EPC. Which one of the two possibilities is selected depends on the Internet Protocol (IP) address the UE is utilizing. If the FMC architecture is based on an S2b or S2c interface between a Packet Data Network Gateway (PDN GW) of the 3GPP EPC and the BBF network domain, two different IP addresses are assigned to the UE: One of these IP addresses is assigned by the 3GPP EPC, and the other is assigned by the BBF network will be offloaded directly to the Internet if the UE makes use of the Local IP address. Accordingly, a decision whether to make use of the possibility of direct offloading or not is taken by the UE. If the FMC architecture is based on an S2a interface between a PDN GW of the 3GPP EPC and the BBF network domain, the UE utilizes only one IP address which is either assigned by the 3GPP EPC or by the BBF network domain. Thus all the traffic is offloaded or not, based on which network domain is assigning the IP address. In other words, either all the traffic of the UE is anchored to the 3GPP EPC or to the BBF network domain.

In the above situation, if the operator of the 3GPP network domain wants to apply policy control to services provided to the UE, it is typically necessary to route all traffic of the UE through the 3GPP EPC, which means that the possibilities of direct offloading cannot be utilized. Further, this means that the 3GPP EPC needs to be dimensioned to also cope with all the traffic generated by the UE while using the BBF access.

Accordingly, there is a need for techniques which allow for efficiently utilizing the possibility of offloading in a multi-domain network.

### SUMMARY

According to an embodiment of the invention, a method of routing data traffic of a UE in a network is provided. The network comprises a first network domain with a gateway providing a first access to a packet network, and a second network domain with a further gateway providing a second access to the packet network. According to the method, a policy controller of the second network domain determines an anchoring rule for controlling whether the gateway selects a first route or a second route for the data traffic. The first route extends between the gateway and the first access, and the second route extends, via the further gateway, between the gateway and the second access. Further, the policy controller sends control data to control application of the anchoring rule by the gateway.

According to a further embodiment of the invention, a method of routing data traffic of a UE in a network is provided. The network comprises a first network domain with a gateway providing a first access to a packet network, and a second network domain with a further gateway providing a second access to the packet network. According to the method, the gateway receives control data from a policy controller of the second network domain. On the basis of the received control data, the gateway applies an anchoring rule to select between a first route or a second route for the data traffic. The first route extends between the gateway gateway and the second access. Further, the policy controller sends control data to control application of the anchoring rule by the gateway.

According to a further embodiment of the invention, a policy controller for controlling data traffic of a UE in a network comprising a first network domain and a second network domain is provided. The first network domain comprises a gateway providing a first access to a packet network, and a the second network domain comprises a further gateway providing a second access to the packet network. The policy controller is configured to control the further gateway of the second network domain. The policy controller comprises a processor configured to determine an anchoring rule for controlling whether the gateway selects a first route or a second route for the data traffic. The first route extending between the gateway and the first access and the second route extends via the further gateway between the gateway and the second access. Further, the policy controller comprises an interface for sending control data to control application of the anchoring rule by the gateway of the first network domain.

According to a further embodiment of the invention, a gateway is provided. The gateway is configured for use in a first network domain of a network. The gateway comprises a first interface for connecting to a UE. Further, the gateway comprises a second interface for providing a first access to a packet network. Further, the gateway comprises a third interface for connecting to a further gateway in a second network domain. The further gateway provides a second access to the packet network. Still further, the gateway comprises a fourth interface for receiving control data from a policy controller of the second network domain. In addition, the gateway comprises a processor. The processor is configured to apply, on the basis of the received control data, an anchoring rule to select between a first route or a second route for data traffic of the UE. The first route extends between the gateway and the first access, and the second route extends, via the further gateway, between the gateway and the second access.

### BRIEF DESCRIPTION OF THE DRAWINGS

FIG. 1 schematically illustrates a multi-domain network architecture in which concepts according to an embodiment of the invention may be applied.

FIG. 2 schematically illustrates a further multi-domain network architecture in which concepts according to an embodiment of the invention may be applied.

FIG. 3 schematically illustrates user plane data transfer between different network domains in the architectures of FIGS. 1 and 2.

FIG. 4 shows a timing diagram for illustrating exemplary procedures for setting up an S2a session in the architecture of FIG. 2.

FIG. 5 shows a timing diagram for illustrating exemplary procedures for setting up an S2a session in the architecture of FIG. 1.

FIG. 6 shows a flowchart for illustrating a method according to an embodiment of the invention.

FIG. 7 shows a flowchart for illustrating a further method according to an embodiment of the invention.

FIG. 8 schematically illustrates a policy controller according to an embodiment of the invention.

FIG. 9 schematically illustrates a gateway according to an embodiment of the invention.

### DETAILED DESCRIPTION OF EMBODIMENTS

In the following, the invention will be explained in more detail by referring to exemplary embodiments and to the accompanying drawings. The illustrated embodiments relate to routing of traffic in a multi-domain network, i.e., in a network including at least a first network domain and a second network domain. In the illustrated examples, the first network domain is a fixed access domain, e.g., a fixed broadband access domain or BBF domain, and the second network domain is a cellular network domain, e.g., a 3GPP domain. However, it is to be understood that the concepts as described herein may also be applied to other types of multi-domain networks. The cellular network domain may be implemented on the basis of radio access technologies such as Global System for Mobile Communications (GSM), Universal Mobile Telecommunications System (UMTS), or Long Term Evolution (LTE).

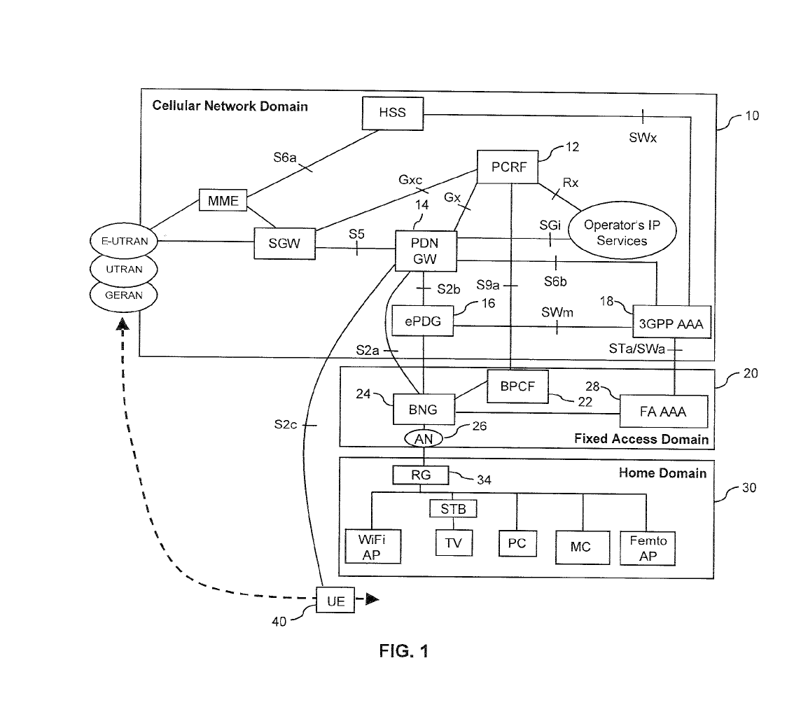

FIG. 1 schematically illustrates an implementation of the multi-domain network. As illustrated, the multi-domain network environment includes a cellular network domain 10 and a fixed access domain 20. The network may also include further network domains, such as home premises devices coupled to the fixed access domain 20. In the home domain, a residential gateway (RG) 34 is provided, which is a communication device at the subscriber premises site, which is used to couple the subscriber premises devices to the fixed access domain 20. In particular, the RG 34 may couple a local area network (LAN) at the subscriber premises site to the fixed access domain 20.

In the illustrated example, the cellular network domain 10 is implemented on the basis of the 3GPP EPC. The cellular network domain 10 includes a PDN GW 14 which is coupled to Radio Access Networks (RANs) via a Serving Gateway (SGW). As illustrated, the RANs may include one or more GSM EDGE RAN (GERAN), UMTS Terrestrial RAN (UTRAN) or Evolved UTRAN (E-UTRAN). In the cellular network domain 10, operator's IP services, e.g., IP Multimedia Subsystem (IMS) services, may be hosted by application servers or the like. A UE 40, e.g., a mobile phone, a portable computer or the like, may access the operator's IP services via the RANs and the PDN GW 14. In addition, the cellular network domain 10 includes a policy controller in the form of a Policy and Charging Rules Function (PCRF) 12. Moreover, the cellular network domain includes a Mobility Management Entity (MME), a subscriber database in the form of a Home Subscriber Server (HSS), and a 3GPP Authentication, Authorization and Accounting (AAA) server 18. Further, for coupling to non-3GPP network domains, e.g., to the fixed access domain 20, the cellular network domain 10 includes an Evolved Packet Data Gateway (ePDG) 16. Further details concerning the above components of the cellular network domain 10 and the interfaces provided between these components can be taken from the 3GPP TSs.

The fixed access domain 20, which in the illustrated example is implemented as a BBF network, includes operator infrastructure for providing fixed network access, e.g., using DSL access technology, optical access technology, or coaxial cable access technology. For this purpose, the fixed access domain includes a Broadband Network Gateway (BNG) 24. The BNG 24 may act as a trusted non-3GPP access gateway according to 3GPP TS 23.402. The BNG 24 is connected to the PDN GW 14 in the cellular network domain 10, which may be accomplished directly using an interface referred to as S2a or indirectly via the ePDG 16. In the latter case, the PDN GW 14 and the ePDG 16 are connected by an interface referred to as S2b. Further, the BNG 24 is connected to the RG 34 in the home domain 30 using a fixed, e.g., wire-based or cable based, communication link. Depending on the access technology used with respect to the RG 34, the fixed access domain 20 may be provided with a corresponding access node (AN) 26, e.g., a DSL Access Multiplexer (DSLAM), an Optical Network Terminal (ONT), or a coaxial cable head end.

Further, the fixed access domain 20 includes a policy controller in the form of a Broadband Policy and Charging Function (BPCF) 22 and a Fixed Access (FA) Authentication, Authorization and Accounting (AAA) server 28.

For allowing communication and interworking between the cellular network domain 10 and the fixed access domain 20, various interfaces are provided: Via an interface referred to as S9a, the PCRF 12 in the cellular network domain 10, is connected to the BPCF 22 in the fixed access domain 20. Further, using an interface referred to as STa or SWa, the 3GPP AAA server 18 may communicate with the FA AAA server 28. Moreover, as mentioned above, the PDN GW 14 and the BNG 24 may communicate using the S2a interface.

The home domain 30 includes the RG 34 and a number of subscriber premises devices connected thereto. In the illustrated example, the subscriber premises devices include a digital entertainment device in the form of a Media Center (MC), a multipurpose computing device in the form of a Personal Computer (PC), a television set (TV) coupled to the RG 34 via a Set-Top-Box (STB), and wireless access points, in particular a WiFi or WLAN Access Point (AP), and a 3GPP Femto Access Point (AP).

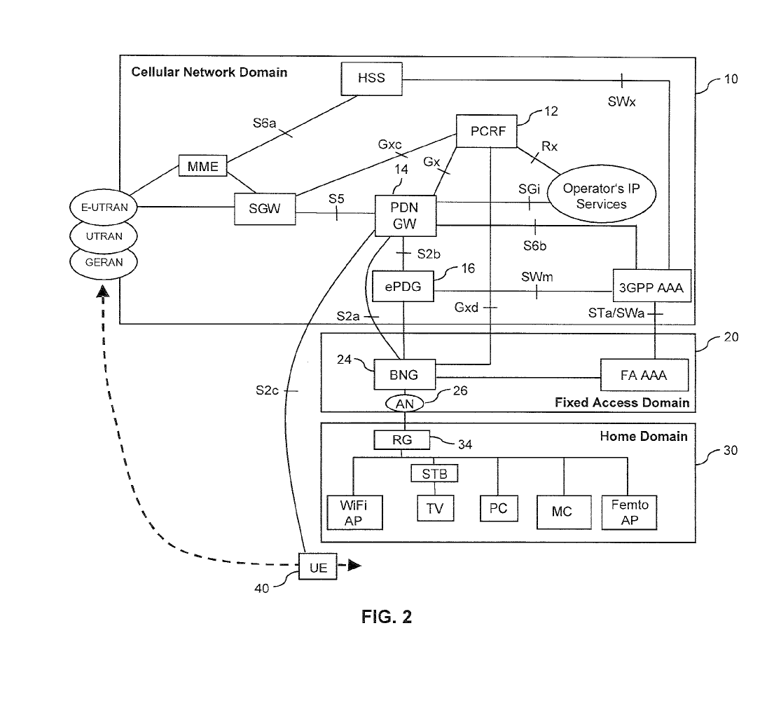

In the network architecture of FIG. 1, both the cellular network domain 10 and the fixed access domain 20 are provided with their own policy controller, i.e., the PCRF 12 and the BPCF 22, respectively. However, in some scenarios, also a common policy controller may be used for both the cellular network domain 10 and the fixed access domain 20. An example of a corresponding architecture is illustrated in FIG. 2. In the architecture of FIG. 2, the PCRF 12 implements as a converged policy controller for both the cellular network domain 10 and the fixed access domain 20. For this purpose, the PCRF 12 is provided with a control interface with respect to the PDN GW 14, i.e., the Gx interface, and a control interface with respect to the BNG 22. In the implementation of FIG. 2, the latter control interface is formed by the Gxd interface.

In the multi-domain network of FIGS. 1 and 2, the UE 40 may move between accesses via the cellular network domain 10, e.g., using GERAN, UTRAN or E-UTRAN, and accesses via the fixed access domain 20, e.g., via the 3GPP Femto AP or the WiFi AP. This is illustrated by the dashed arrow. When the UE 40 uses an access via the fixed access domain 20, it may still connect to the operator's IP services in the cellular network domain 10 by using the illustrated S2a, S2b or S2c interfaces. Further, a connection of the UE 40 to an external packet network, e.g., to the Internet or some IP based service network, can be established say, for traffic between the UE 40 and the packet network, either a first route or a second route may be selected. The first route extends between the BNG 22 and an access of the fixed access domain 20 to the packet network. The second route extends, via the PDN GW 14, between the BNG 22 and an access of the cellular network domain 10 to the packet network. Using the first route to offload the traffic directly to the packet network, without passing through the cellular network domain 10 and in particular the 3GPP EPC, may also be referred to as non-seamless offload.

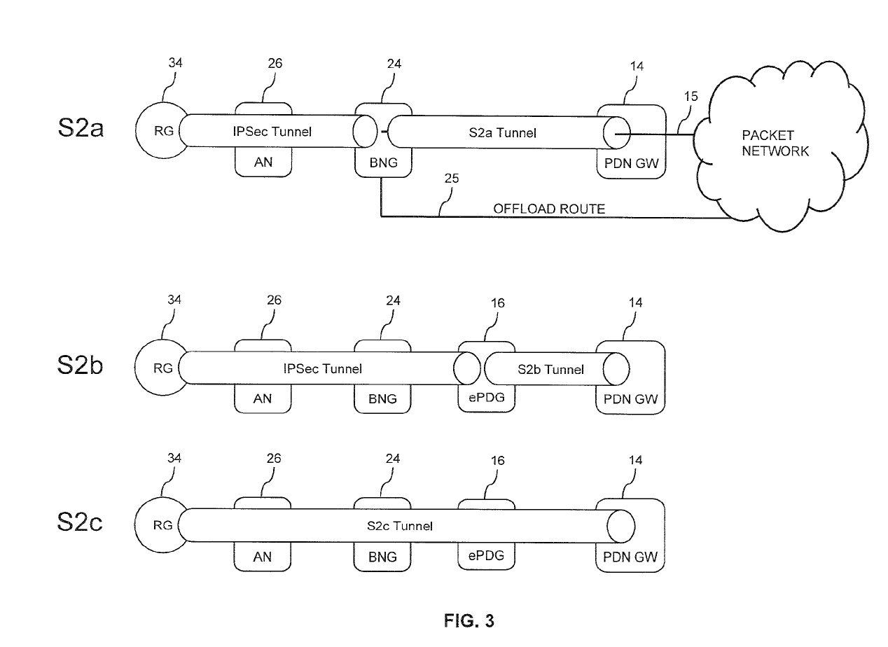

FIG. 3 further illustrates handling of the traffic in the user plane when using the above-mentioned S2a, S2b, and S2c interfaces, in particular with respect to tunnels which serve as security mechanism between the involved nodes. As illustrated, the S2a interface involves an IPSec tunnel between the RG 34 and the BNG 24, and an S2a tunnel between the BNG 24 and the PDN GW 14. The S2a tunnel may be implemented using GTP (General Packet Radio Service Tunneling Protocol) or PMIP (Proxy Mobile IP). The S2b interface involves an IPSec tunnel between the RG 34 and the ePDG 16, and an S2b tunnel between the ePDG 16 and the PDN GW 14. The S2b tunnel may be implemented using GTP or PMIP. The S2c interface involves an S2c tunnel between the RG 34 and the PDN GW 14. The S2c tunnel may be implemented using Dual Stack Mobile IP.

As can be seen from FIG. 3, when using the S2a interface, the BNG 22 acts as a terminating and starting point for security tunnels. For the S2b and S2c interfaces, the security tunnels cross the fixed access domain 20 towards the cellular network domain 10. The concepts as explained in the following involve using the BNG 22 as a node in which an anchoring rule concerning the offloading of traffic is applied. The offloading can be implemented on the basis of the above-mentioned S2a interface by replacing the route 15 extending via the S2a tunnel and the PDN GW 14 to the packet network with a direct route to the access of the fixed access domain 20 to the packet network, as illustrated by offload route 25. The offload route 25 corresponds to the above-mentioned first route, and the route 15 corresponds to the above-mentioned second route.

According to concepts as described herein, a policy controller of the cellular network domain, e.g., the PCRF 12, may indicate the anchoring rule to the BNG 22. The anchoring rule controls whether the traffic is directed to the first route 25 or to the second route 15, i.e., whether the traffic is routed directly to the packet network or whether it is routed through the cellular network domain. This may be accomplished on the level of IP packet flows, e.g., by providing the anchoring rule with a packet filter for selecting a certain IP packet flow. The packet flows are directed to the second route 15. In the architectures of FIG. 1, the PCRF 12 may indicate the anchoring rule by sending corresponding information on the S9a interface to the BPCF 22. The BPCF 22 may in turn send corresponding control information to the BNG 24. In the architecture of FIG. 2, the PCRF 12 may indicated the anchoring rule by directly sending corresponding information to the BNG 24, using the Gxd interface.

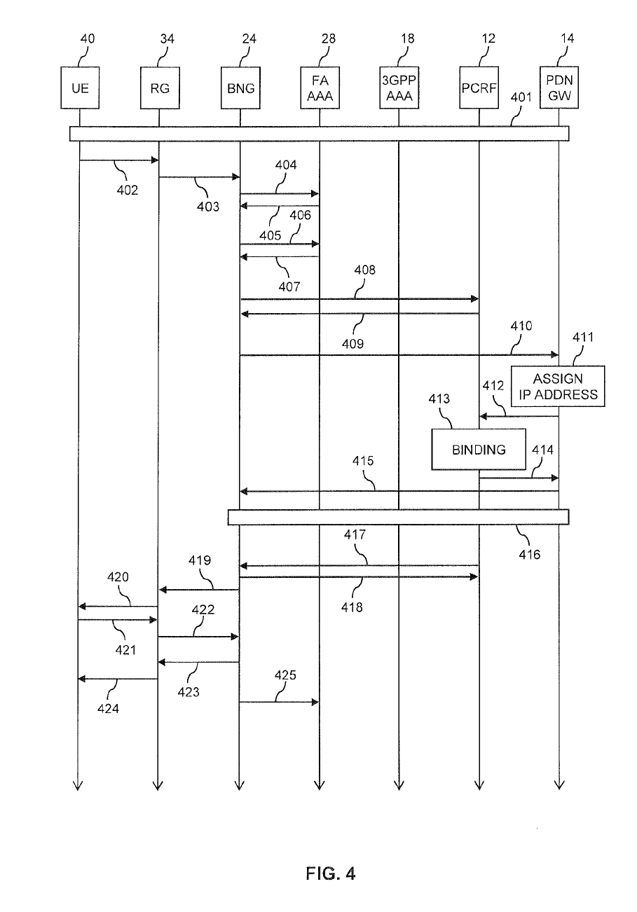

FIG. 4 shows a timing diagram for S2a session setup in an architecture as illustrated in FIG. 2. As mentioned above, the architecture of FIG. 2 is based on a convergent PCRF 12 which acts as a policy controller for both the cellular network domain 10 and the fixed access domain 20. The procedures involve the UE 40, the RG 34, the BNG 24, the FA AAA 28, the 3GPP AAA 18, the PCRF 12, and the PDN GW 14 and may be in accordance with the specifications of section 7.7.1 of 3GPP TS 23.203.

At step 401, 3GPP authentication of the UE 40 is performed. This may be accomplished according to IEEE 802.1.

The UE 40 may then send message 402 with a Dynamic Host Configuration Protocol Version 4 (DHCPv4) Discover message to the RG 34. With message 403, the RG 34 forwards the DHCPv4 Discover message to the BNG 24.

The BNG 24 then performs authorization within the fixed access domain 20. For this purpose, the BNG 24 sends message 404 including a RADIUS Access Request and the Medium Access Control (MAC) address of the UE 40 to the FA AAA 28. In the illustrated scenario, the FA AAA 28 responds by sending message 405 to the BNG 24. Message 405 includes a RADIUS Access Accept message and may indicate an International Mobile Subscriber Identity (IMSI) or Mobile Subscriber Integrated Services Digital Network Number (MSISDN) of the UE 40 to the BNG 24. Further, the BNG 24 sends message 406 to the FA AAA 28. Message 406 includes a RADIUS Accounting Start message with the IMSI or MSISDN and a Session Start indicator. The FA AAA 28 responds by sending message 407 to the BNG 24. Message 407 includes a RADIUS Accounting acknowledgement message.

The BNG 24 then proceeds by setting up a gateway control session with the PCRF 12. For this purpose, the BNG 24 sends message 408 to the PCRF 12. Message 408 is sent on the Gxd interface and includes a Gateway Control Request and the IMSI or MSISDN, which is used as a subscription identifier. The PCRF 12 responds by sending message 409 to the BNG 24. Message 409 includes a Gateway Control Response and default Quality of Service includes a Create Session Request. At step 411, the PDN GW 14 assigns an IP address to the UE 40. In some scenarios, the IP address could also be assigned by some other node of the cellular network domain 10, e.g., by the 3GPP AAA during RADIUS authentication. The PDN GW 14 then sends message 412 to the PCRF 12. Message 412 includes an IP Connectivity Access Network (IP-CAN) Session Establishment message. At step 413, the PCRF 12 performs binding between the IP-CAN session and the Gateway Control session. The PCRF 12 then sends message 414 to the PDN GW 14. Message 414 includes an IP-CAN Session Establishment Acknowledgement. The PDN GW 14 then responds to message 410 by sending message 415 to the BNG 24. Message 415 includes a Create Session Response and indicates the IP address assigned at step 411. The BNG 24 and the PDN GW 14 may then proceed by setting up an S2a tunnel, as indicated by step 416.

Further, the PCRF 12 sends message 417 to the BNG 24. Message 417 may be a Re-Authentication Request (RAR) command for provisioning gateway control rules, e.g., QoS rules. The BNG 24 responds by sending message 418 to the PCRF 12. Message 418 may be a Re-Authentication Answer (RAA) command for acknowledging the RAR command of message 417.

The BNG 24 then responds to message 403 by sending message 419 to the RG 34. Message 419 includes a DHCPv4 Offer message and indicates the IP address assigned at step 411. By sending message 420 to the UE 40, the RG 34 forwards the DHCPv4 Offer and indicates the IP address to the UE 40.

The UE 40 may then initiate a user plane session by sending message 421, including a DHCPv4 Request message, to the RG 34. By sending message 422, the RG 34 forwards the DHCPv4 Request to the BNG 24. The BNG 24 responds by sending message 423 to the RG 34. Message 423 includes a DHCPv4 Acknowledgement message. By sending message 424, the RG 34 forwards the DHCPv4 Acknowledgement message to the UE 40. Upon initiating the user plane session, the BNG 24 may send message 425 to the FA AAA 28. Message 425 may for example include a RADIUS Accounting Update message and indicate the IMSI, MSISDN, or IP address of the UE 40.

In the procedures of FIG. 4, the anchoring rule may be provided to the BNG 24 in message 409 and/or in message 417. Accordingly, the anchoring rule may be provided as corresponding data element in existing messages of the Gxd interface. Alternatively, dedicated messages for indicating the anchoring rule may be used.

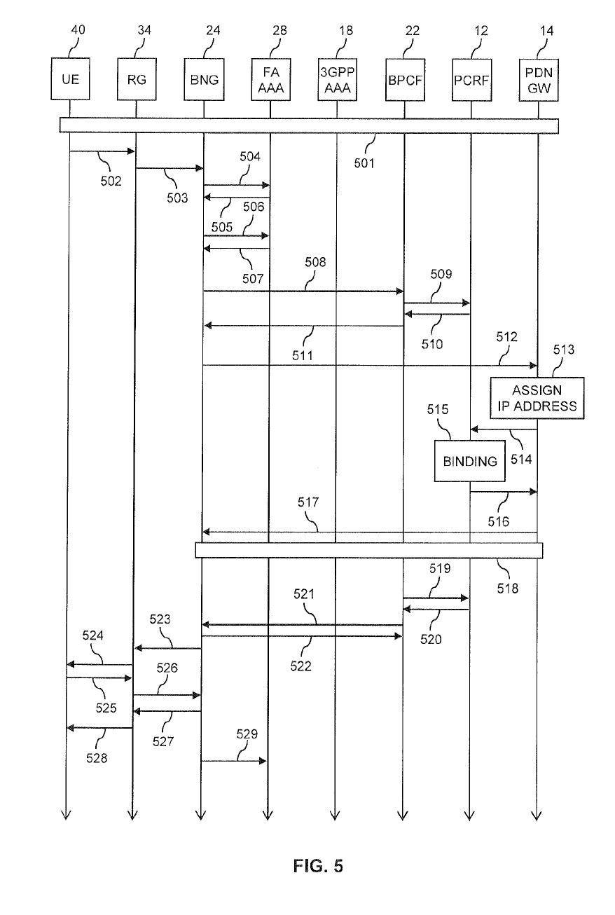

FIG. 5 shows a timing diagram for S2a session setup in an architecture as illustrated in FIG. 1. The architecture of FIG. 1 is based on interworking between the PCRF 12 and the BPCF 22. The procedures involve the UE 40, the RG 34, the BNG 24, the FA AAA 28, the 3GPP AAA 18, the BPCF 22, the PCRF 12, and the PDN GW 14.

At step 501, 3GPP authentication of the UE 40 is performed. This may be accomplished according to IEEE 802.1.

The UE 40 may then send message 502 with a DHCPv4 Discover message to the RG 34. With message 503, the RG 34 forwards the DHCPv4 Discover message to the BNG 24.

The BNG 24 then performs authorization within the fixed access domain 20. For this purpose, the BNG 24 sends message 504 including a RADIUS Access Request and the MAC address of the UE 40 to the FA AAA 28. In the illustrated scenario, the FA AAA 28 responds by sending message 505 to the BNG 24. Message 505 includes a RADIUS Access Accept message and may indicate an IMSI or MSISDN of the UE 40 to the BNG 24. Further, the BNG 24 sends message 506 to the FA AAA 28. Message 506 includes a RADIUS Accounting Start message with the IMSI or MSISDN and a Session Start indicator. The FA AAA 28 responds by sending message 507 to the BNG 24. Message 507 includes a RADIUS Accounting acknowledgement message.

The BNG 24 then proceeds by setting up a control session with the BPCF 22. For this purpose, the BNG 24 sends message 508 to the BPCF 22. Message 508 is sent on a control interface between the BNG 24 and the BPCF 22, e.g., based on a RADIUS CoA protocol. Message 508 includes the IMSI or MSISDN, which is used as a subscription identifier. The BPCF 22 then sends message 509 to the PCRF 12 to establish an S9a control session. Message 509 includes the IMSI or MSISDN, which is again used as a subscription identifier. The PCRF 12 responds by sending message 510 to the PCRF 12. Message 510 may include default QoS Rules. The BPCF 22 then responds to message 508 by sending message 511 to the BNG 24. Message 511 may indicate the default QoS rules to the BNG 24.

Further, the BNG 24 sends message 512 to the PDN GW 14. Message 512 includes a Create Session Request. At step 513, the PDN GW 14 assigns an IP address to the UE 40. In some scenarios, the IP address could also be assigned by some other node of the cellular network domain 10, e.g., by the 3GPP AAA during RADIUS authentication. The PDN GW 14 Network (IP-CAN) Session Establishment message. At step 515, the PCRF 12 performs binding between the IP-CAN session and the S9a control session. The PCRF 12 then sends message 516 to the PDN GW 14. Message 516 includes an IP-CAN Session Establishment Acknowledgement. The PDN GW 14 then responds to message 512 by sending message 517 to the BNG 24. Message 517 includes a Create Session Response and indicates the IP address assigned at step 513. The BNG 24 and the PDN GW 14 may then proceed by setting up an S2a tunnel, as indicated by step 518.

Further, the PCRF 12 sends message 519 to the BPCF 22. Message 519 may be an S9a control session update message, e.g., for providing updated QoS rules to the BPCF 22. The BPCF 22 responds by sending message 520 to the PCRF 12. Message 520 may be an S9a control session update acknowledgement. The BPCF 22 in turn sends message 521 to the BNG 24. Message 521 may be a control session update request for provisioning gateway control rules, e.g., QoS rules. The BNG 24 responds by sending message 522 to the BPCF 22. Message 522 message for acknowledging the update request of message 521.

The BNG 24 then responds to message 503 by sending message 523 to the RG 34. Message 523 includes a DHCPv4 Offer message and indicates the IP address assigned at step 513. By sending message 524 to the UE 40, the RG 34 forwards the DHCPv4 Offer and indicates the IP address to the UE 40.

The UE 40 may then initiate a user plane session by sending message 525, including a DHCPv4 Request message, to the RG 34. By sending message 526, the RG 34 forwards the DHCPv4 Request to the BNG 24. The BNG 24 responds by sending message 527 to the RG 34. Message 527 includes a DHCPv4 Acknowledgement message. By sending message 528, the RG 34 forwards the DHCPv4 Acknowledgement message to the UE 40. Upon initiating the user plane session, the BNG 24 may send message 529 to the FA AAA 28. Message 529 may for example include a RADIUS Accounting Update message and indicate the IMSI, MSISDN, or IP address of the UE 40.

In the procedures of FIG. 5, the anchoring rule may be provided to the via the BPCF 22 to the BNG 24, using messages 510 and 511 and/or using messages 519 and message 521. Accordingly, the anchoring rule may be provided as corresponding data element in existing messages of the S9a interface and of the control interface between the BPCF 22 and the BNG 24. Alternatively, dedicated messages for indicating the anchoring rule may be used.

The anchoring rule may include a rule name, one or more packet filters, an anchoring indication, and/or usage monitoring information. The rule name may be used to reference a certain anchoring rule in the communication between the BNG 24 and the PCRF 12. The packet filter(s) shall be used to select the traffic for which the rule applies. The packet filter(s) may have a similar configuration as Service Data Flow (SDF) filters used for defining QoS rules or Policy and Charging Control (PCC) rules, e.g., operate on the basis of an IP 5-tuple. The anchoring indication may be used to specify whether the BNG 24 should select the first route 25 or the second route 15 for the traffic as identified by the packet filter(s). In other words, the anchoring indication may define SDFs matching the anchoring rule shall be routed through the cellular network domain 10, in particular the 3GPP EPC, or directly between the fixed access domain and the packet network. The usage monitoring information may include data for usage monitoring control at the BNG 24.

In an exemplary implementation, the anchoring rule may be selected from two different types of anchoring rules, dynamic anchoring rules and pre-defined anchoring rules. Dynamic anchoring rules are anchoring rules pertaining to traffic, e.g., defined in terms of an SDF or IP packet flow, which is known to the PCRF 12. For example, the PCRF 12 may have received an indication or information concerning the traffic from another node, e.g., from an Application Function (AF), e.g., via an Rx interface of the PCRF 12, or from a Traffic Detection Function (TDF), e.g., via an Sd interface of the PCRF 12. As compared to that, for pre-defined anchoring rules the PCRF 12 is not aware of the particular traffic, e.g., in terms of an SDF or IP packet flow. For such anchoring rules, the packet filter(s) may be statically configured in the BNG 24.

The PCRF 12 may use signaling to the BNG 24 to control application of the anchoring rule by the gateway. For a dynamic anchoring rule this control may include procedures for installation of a new anchoring rule, which was not yet provisioned in the BNG 24, modification of an already installed anchoring rule in the BNG 24, and/or removal of an installed anchoring rule from the BNG 24. For a pre-defined anchoring rule this control may include activation or deactivation of the anchoring rule configured in the BNG 24. In the architecture of FIG. 2, the PCRF 12 may perform this control through the Gxd interface. In the architecture of FIG. 1, the PCRF 12 may perform this control indirectly through the S9a interface to the BPCF 22 and a control interface between the BPCF 22 and the BNG 24.

In the architecture of FIG. 2, the operations for controlling the application of the anchoring rule by the BNG 24 may be part of Gateway Control session procedures as defined in 3GPP TS 24 at Gateway Control session establishment or modification, one or more anchoring rules may be removed or deactivated at Gateway Control session modification or termination, and/or one or more anchoring rules may be modified at Gateway Control session modification. In the architecture of FIG. 1, the operations for controlling the application of the anchoring rule may involve S9a control procedures. In particular, one or more anchoring rules may be installed or activated in the BNG 24 at S9a control session establishment or modification, one or more anchoring rules may be removed or deactivated at S9a control session modification or termination, and/or one or more anchoring rules may be modified at S9a control session modification.

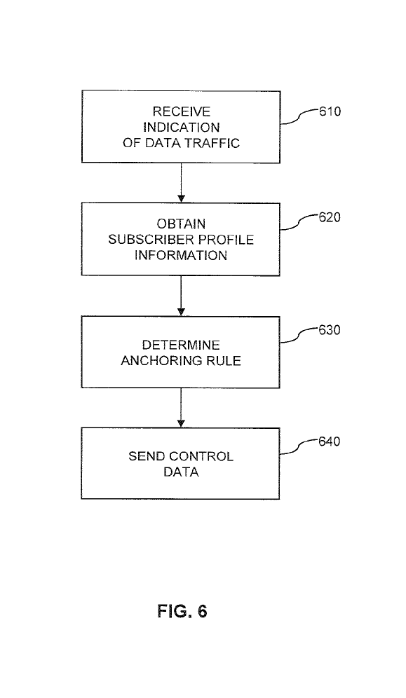

FIG. 6 shows a flowchart for illustrating a method for routing data traffic of a UE in a multi-domain network. The method may be used for implementing the above concepts in a policy controller, e.g., in the PCRF 12 of FIG. 1 or 2. The network includes a first network domain, e.g., a fixed access domain such as the fixed access domain 20, and a second network domain, e.g., a cellular network domain such as the cellular network domain 10. The first network domain includes a gateway, e.g., the BNG 24. The second network domain includes a further gateway, e.g., the PDN GW 14. The first gateway provides a first access to a packet network, and the second gateway provides a second access to the packet network. As mentioned above, the packet network may be the Internet or some IP based service network. The policy controller controls the gateway of the second network domain, i.e., is a policy controller of the second network domain. In some scenarios, the policy controller may perform policy control in both network domains, e.g., as explained for the converged PCRF 12 in the architecture of FIG. 2.

At step 610, the policy controller may receive an indication of data traffic. For example, if the policy controller is a PCRF, it may receive information concerning an SDF or IP packet flow of the data traffic via the Rx interface, e.g., from an AF, or via the Sd interface, e.g., from a TDF. In particular, such information may indicate that the data traffic, e.g., a certain SDF or IP packet flow, is associated with a certain service. The service may have been identified using Deep Packet Inspection. The indication of the data traffic may also be included in signaling for IP CAN session establishment or modification, e.g., as received via the Gx or S9a interface.

At step 620, the policy controller may obtain subscriber profile information associated with the UE. For example, in the architecture of FIG. 1 or 2, the PCRF 12 may obtain such subscriber profile information from a corresponding database in the HSS.

At step 630, the policy controller determines an the anchoring rule. The anchoring rule has the purpose of controlling whether the gateway of the first network domain selects a first route or a second route for the data traffic. For example, the anchoring rule may include indication of the route to be selected, e.g., in the form of the above-mentioned anchoring indication. The first route extends between the gateway and the first access, and the second route extends, via the further gateway in the second network domain, between the gateway and the second access. The first route may be the above-mentioned route 25, and the second route may be the above-mentioned route 15.

The policy controller may determine the anchoring rule depending on the indication of data traffic received at step 610 and/or depending on the subscriber profile information obtained at step 620. The policy controller may for example determine the anchoring rule on the basis of a service associated with the data traffic, and this may be accomplished taking into account the subscriber profile information. In this way, it can be achieved that the first route is selected for a given service, while the second route is selected for another service. This behavior may vary in accordance with the subscriber profile information.

At step 640, the policy controller sends control data to control application of the anchoring rule by the gateway. This can be accomplished directly, e.g., via the Gxd interface as explained for the architecture of FIG. 2, or indirectly, e.g., via the S9a interface as explained for the architecture of FIG. 1. The control data may control activation or deactivation of the anchoring rule in the gateway, may control modification of the anchoring rule in the gateway, and/or may include the anchoring rule. The anchoring rule may include a packet filter configured to select the data traffic, e.g., in terms of SDFs or IP packet flows. As used herein, an IP packet flow is considered as a series of IP data packets carrying the same source and destination addresses, typically also the same source and destination ports and/or protocol identifier. An SDF is considered to be an IP packet flow related to a particular service. Accordingly, the data traffic may be selected in terms of an SDF or IP packet flow by configuring the packet filter to match a certain IP 5-tuple of IP data packets.

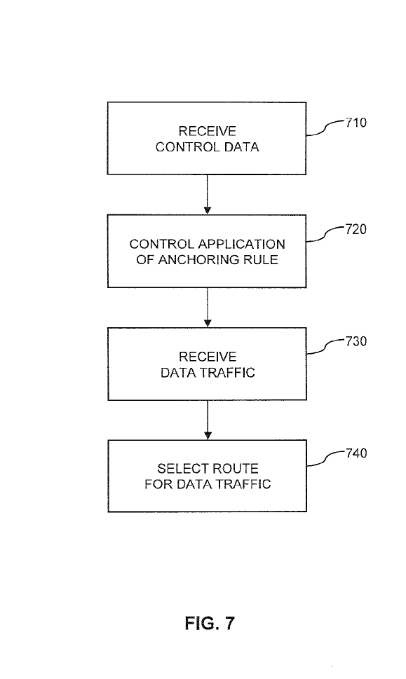

FIG. 7 shows a flowchart for illustrating a further method for routing data traffic of a UE in a multi-domain network. The method may be used for implementing the above concepts in a gateway, e.g., in the BNG 24 of FIG. 1 or 2. The network includes a first network domain, e.g., a fixed access domain such as the fixed access domain 20, and a second network domain, e.g., a cellular network domain such as the cellular network domain 10. The first network domain includes the gateway. The second network domain includes a further network, and the second gateway provides a second access to the packet network. As mentioned above, the packet network may be the Internet or some IP based service network.

At step 710, the gateway receives control data from a policy controller of the second network domain, e.g., from the PCRF 12 of FIG. 1 or 2. This can be accomplished directly, e.g., via the Gxd as explained for the architecture of FIG. 2, or indirectly, e.g., via the S9a interface as explained for the architecture of FIG. 1.

At step 720, the gateway applies an anchoring rule to select between a first route or a second route for the data traffic. For example, the anchoring rule may include indication of the route to be selected, e.g., in the form of the above-mentioned anchoring indication. The first route extends between the gateway and the first access, and the second route extends, via the further gateway in the second network domain, between the gateway and the second access. The first route may be the above-mentioned route 25, and the second route may be the above-mentioned route 15. The gateway applies the anchoring rule on the basis of the control data received at step 710.

On the basis of the control data, the gateway may control activation or deactivation of the anchoring rule, or may control modification of the anchoring rule. Further, the control data may include the anchoring rule, and the gateway may install the anchoring rule received with the control data. The anchoring rule may include a packet filter configured to select the data traffic, e.g., in terms of SDFs or IP packet flows. The data traffic may be selected in terms of an SDF or IP packet flow by configuring the packet filter to match a certain IP 5-tuple of IP data packets.

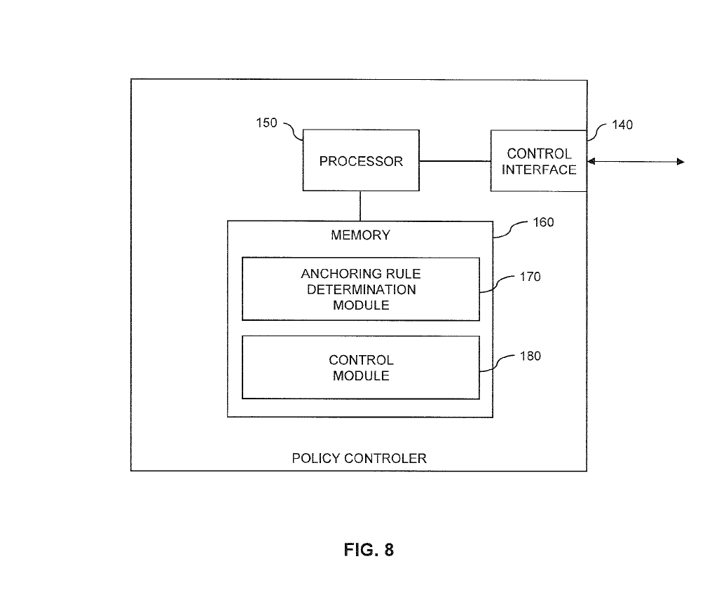

FIG. 8 schematically illustrates exemplary structures for implementing the above-described concepts in a policy controller, e.g., a policy controller in a cellular network domain such as the PCRF 12.

In the illustrated structure, the policy controller includes a control interface 140 for communicating with other nodes of the network, in particular with gateways in different network domains. In particular, for controlling a gateway in a cellular network domain, the control interface 140 may implement the Gx interface, and for controlling a gateway in a fixed access domain, the control interface 140 may implement the S9a interface or the Gxd interface.

Further, the policy controller includes a processor 150 coupled to the interface 140 and a memory 160 coupled to the processor 150. The memory 160 may include a Read Only Memory (ROM), e.g., a flash ROM, a Random Access Memory (RAM), e.g., a Dynamic RAM (DRAM) or Static RAM (SRAM), a mass storage, e.g., a hard disk or solid state disk, or the like. The memory 160 includes suitably configured program code to be executed by the processor 150 so as to implement the above-described functionalities of the policy controller. More specifically, the memory 160 may include an anchoring rule determination module 170 for accomplishing the above-described determination of an anchoring rule. Further, the memory 160 may include a control module 180 for performing various control procedures, e.g., sending of control data to control application of the anchoring rule.

It is to be understood that the structure as illustrated in FIG. 8 is merely schematic and that the policy controller may actually include further components which, for the sake of clarity, have not been illustrated, e.g., further interfaces or additional processors. Also, it is to be understood that the memory 160 may include further types of program code modules, which have not been illustrated. For example, the memory 160 may include program code modules for implementing typical functionalities of a policy controller, e.g., known functionalities of a PCRF or converged PCRF. According to some embodiments, also a computer program product may be provided for implementing concepts according to embodiments of the invention, e.g., a computer-readable medium storing the program code and/or other data to be stored in the memory 160.

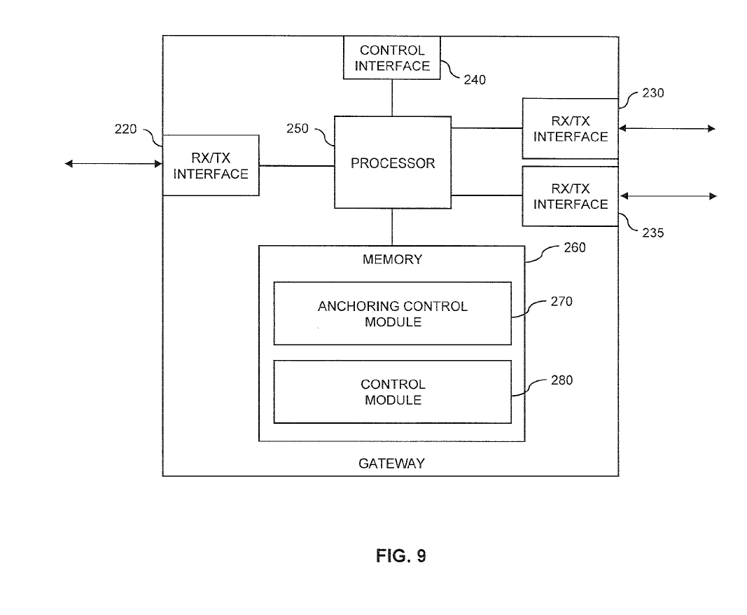

FIG. 9 schematically illustrates exemplary structures for implementing the above-described concepts in a gateway, e.g., a gateway in a fixed access domain such as the BNG 24.

In the illustrated structure, the gateway includes a first interface 220, a second interface 230, and a third interface 235. The interfaces 220, 230, 235 may be configured as transmit (TX)/receive (RX) interfaces for receiving and/or transmitting user plane data. The interface 220 may be used for connecting to the UE. The interface 230 may be used for connecting to the first access to the packet network, whereas the interface 235 may be used for connecting, via the further gateway in the second network domain, to the second access to the packet network. The interface 235 may implement to the above-mentioned S2a interface. In addition, the gateway includes a control interface 240 for receiving control data from a policy controller, e.g., a PCRF. In an architecture as illustrated in FIG. 2, the control interface 240 may implement the Gxd interface. In an architecture as illustrated in FIG. 1, the control interface 240 may be with respect to a policy controller in the fixed access domain such as the BPCF 22, which in turn is equipped with the S9a interface to the PCRF 12 in the cellular network domain.

Further, the gateway includes a processor 250 coupled to the interface 220, 230, 235, 240 and a memory 260 coupled to the processor 250. The memory 260 may include a ROM, e.g., a flash ROM, a RAM, e.g., a DRAM or SRAM, a mass storage, e.g., a hard disk or solid state disk, or the like. The memory 260 includes suitably configured program code to be executed by the processor 250 so as to implement the above-described functionalities of the gateway. More specifically, the memory 260 may include an anchoring control module 270 for controlling the application of an anchoring rule in the above-described manner. Further, the memory 260 may include a control module 280 for performing various control procedures, e.g., evaluation of received control data or control procedures for enforcing QoS rules.

It is to be understood that the structure as illustrated in FIG. 9 is merely schematic and that the gateway may actually include further components which, for the sake of clarity, have not been illustrated, e.g., further interfaces or additional processors. Also, it is to be understood that the memory 260 may include further types of program code modules, which have not been illustrated. For example, the memory 260 may include program code modules for implementing typical functionalities of a gateway, e.g., known functionalities of a BNG. According to some embodiments, also a computer program product may be provided for implementing concepts according to embodiments of the invention, e.g., a computer-readable medium storing the program code and/or other data to be stored in the memory 260.

As can be seen, concepts as described herein may be used to achieve efficient offloading of data traffic in a multi-domain network. The routing of data traffic may be controlled not just based on static subscriber profile information, but also based on the service associated with the data traffic. Further, a decision whether to apply offloading or not is taken in the network and not by the UE. Hence, cellular network domain operators may decide that low value flows, but high bandwidth consumers, as for example certain video streams, shall be offloaded directly to Internet without applying operator's policy control. However, high value flows and low bandwidth consumers, such as Voice over LTE, can be kept controlled in the operator's packet core to ensure appropriate Quality of Experience (QoE). Further, the concepts allow for avoiding excessive load on the cellular network domain's core network because only services which require policy control in the cellular network domain may be routed through the cellular network domain.

It is to be understood that the concepts as explained above are merely exemplary and susceptible to various modifications. For example, the concepts may be applied in various types of communication networks with multiple domains. Further, it is to be understood that the illustrated nodes may each be implemented by a single device or by multiple devices. Moreover, the concepts may be implemented by dedicated hardware and/or by software to be executed by a multipurpose processor in one of the involved nodes.

1-19. (canceled)

20. A method of routing data traffic of a user equipment in a network, the network comprising a first network domain with a first gateway providing a first access to a packet network and a second network domain with a second gateway providing a second access to the packet network, the method comprising:
determining, by a policy controller of the second network domain and based on a service associated with the data traffic, an anchoring rule for controlling whether the first gateway selects a first route or a second route for the data traffic, the first route extending between the first gateway and the first access, and the second route extending via the second gateway between the first gateway and the second access; and
the policy controller sending control data to control application of the anchoring rule by the gateway.

21. The method of claim 20, wherein the control data controls activation of the anchoring rule in the first gateway.

22. The method of claim 20, wherein the control data controls modification of the anchoring rule in the first gateway.

23. The method of claim 20, wherein the control data includes the anchoring rule.

24. The method of claim 20, wherein the anchoring rule comprises a packet filter configured to select the data traffic.

25. The method of claim 20, wherein the determining comprises determining the anchoring rule further based on subscriber profile information associated with the user equipment.

26. The method of claim 20, wherein the first network domain is a fixed access domain.

27. The method of claim 20, wherein the second network domain is a cellular network domain.

28. A method of routing data traffic of a user equipment in a network, the network comprising a first network domain with a first gateway providing a first access to a packet network and a second network domain with a second gateway providing a second access to the packet network, the method comprising:
the first gateway receiving control data from a policy controller of the second network domain; and
based on the received control data, the first gateway applying an anchoring rule to select, depending on a service associated with the data traffic, between a first route or a second route for the data traffic, the first route extending between the first gateway and the first access, and the second route extending via the second gateway between the first gateway and the second access.

29. The method of claim 28, wherein the first gateway controls activation of the anchoring rule based on the control data.

30. The method of claim 28, wherein the first gateway modifies the anchoring rule based on the control data.

31. The method of claim 28:
wherein the control data includes the anchoring rule;
wherein the first gateway installs the anchoring rule received with the control data.

32. The method of claim 28, wherein the anchoring rule comprises a packet filter configured to select the data traffic.

33. The method of claim 28, wherein the first network domain is a fixed access domain.

34. The method of claim 28, wherein the second network domain is a cellular network domain.

35. A policy controller for controlling data traffic of a user equipment in a network, the network comprising a first network domain with a first gateway providing a first access to a packet network and a second network domain with a second gateway providing a second access to the packet network, the policy controller configured to control the gateway of the second network domain and comprising:
one or more processing circuits configured to determine, based on a service associated with the data traffic, an anchoring rule for controlling whether the gateway selects a first route or a second route for the data traffic, the first route extending between the first gateway and the first access and the second route extending via the second gateway between the first gateway and the second access; and
an interface for sending control data to control application of the anchoring rule by the first gateway.

36. A first gateway for use in a first network domain of a network, the gateway comprising:
a first interface configured to connect to a user equipment;
a second interface configured to provide a first access to a packet network;
a third interface configured to connect to a second gateway in a second network domain, the second gateway providing a second access to the packet network;
a fourth interface configured to receive control data from a policy controller of the second network domain; and
one or more processing circuits configured to apply, based on the received control data, an anchoring rule to select, depending on a service associated with the data traffic, between a first route or a second route for data traffic of the user equipment, the first route extending between the first gateway and the first access, and the second route extending via the second gateway between the first gateway and the second access.
